(19) United States
(12) Patent Application Publication
(10) Pub. No.: US 2011/0035562 A1
(43) Pub. Date: Feb. 10, 2011

(54) PROVIDING MIRRORING WRITE DATA

(75) Inventor: Blaine D. GAITHER, Ft. Collins, CO (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/538,340

(22) Filed: Aug. 10, 2009

(51) Int. Cl. G06F 12/00; G06F 12/16

(52) U.S. Cl. 711/162; 711/E12.103

(57) ABSTRACT

An apparatus, method, and system are described. In one embodiment, the system is configured to store, in a non-volatile memory, mirroring data intended for a member of a set of mirroring drives that is in a powered-down state.

### BACKGROUND

In the field of computer data storage, a pair of drives may be arranged as a primary drive and a secondary drive to facilitate mirroring data. Data written to the primary drive may also be written to the secondary drive as a precaution. Therefore, the drives may be said to be arranged as mirroring drives, where the primary is mirrored, and the secondary does the mirroring. Conventionally, mirroring drives have been maintained in a powered-up state so that writes intended for a primary, mirrored drive can be substantially simultaneously written to both the primary, mirrored drive and to a secondary, mirroring drive. Reads have conventionally been satisfied from the primary, mirrored drive. Both the primary, mirrored drive and the secondary, mirroring drive are maintained in the powered-up state to facilitate writing and to minimize delays associated with failover processing. This may waste power.

### BRIEF DESCRIPTION OF THE DRAWINGS

The accompanying drawings illustrate various example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa.

FIG. 1 illustrates an embodiment that includes control logic, a non-volatile memory, and a pair of drives arranged in a mirroring configuration.

FIG. 2 illustrates an embodiment that includes control logic, a non-volatile memory, and a pair of drives arranged in a mirroring configuration.

FIG. 3 illustrates an embodiment that includes control logic, a non-volatile memory, and a pair of drives arranged in a mirroring configuration.

FIG. 4 illustrates an embodiment of a method associated with providing mirroring write data to a non-volatile memory.

FIG. 5 illustrates an embodiment of a method associated with providing mirroring write data to a non-volatile memory.

FIG. 6 illustrates an embodiment of a computing environment in which example apparatus and methods associated with providing mirroring write data to a non-volatile memory may operate.

### DEFINITIONS

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, element or limitation. Furthermore, repeated use of the phrase “in one embodiment” does not necessarily refer to the same embodiment.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: static RAM.

ROM: read only memory.

PROM: programmable ROM.

EPROM: erasable PROM.

EEPROM: electrically erasable PROM.

USB: universal serial bus.

WAN: wide area network.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

### DETAILED DESCRIPTION

Example apparatus and methods facilitate saving power by providing mirroring write data to a non-volatile memory while a mirroring drive is in a powered-down state. One embodiment includes an apparatus. The apparatus includes control logic. The control logic is configured to be operatively coupled to a non-volatile memory and to a plurality of drives organized in a mirroring configuration. Being operatively coupled includes being able to send and/or receive electrical signals including data and control signals. The mirroring configuration includes a primary drive and a secondary drive. The control logic functions to selectively provide mirroring write data intended to be written to the secondary drive to the non-volatile memory when the secondary drive is in a powered-down state. This facilitates keeping the secondary drive in a powered-down state, which in turn facilitates saving power. Data can be written to the secondary drive when it enters a powered-up state. In one embodiment, the write may include a write operation that requests certain data to be written to a designated location.

Another embodiment describes a method. The method includes interfacing with a pair of drives that are operating as a pair of mirroring drives. To save power, one member of the pair of drives is controlled to be in a powered-up, mirrored state and one member of the pair of drives is controlled to be in a powered-down, mirroring state. Since one drive is powered-up, writes intended for that drive can be sent to that drive. Since another drive is powered-down, writes intended for the powered-down drive are not sent to that drive. Instead, writes intended for the drive in the powered-down, mirroring state are provided to a non-volatile memory. Data can be written from the non-volatile memory to the drive in the powered-down mirroring state when it enters a powered-up mirroring state.

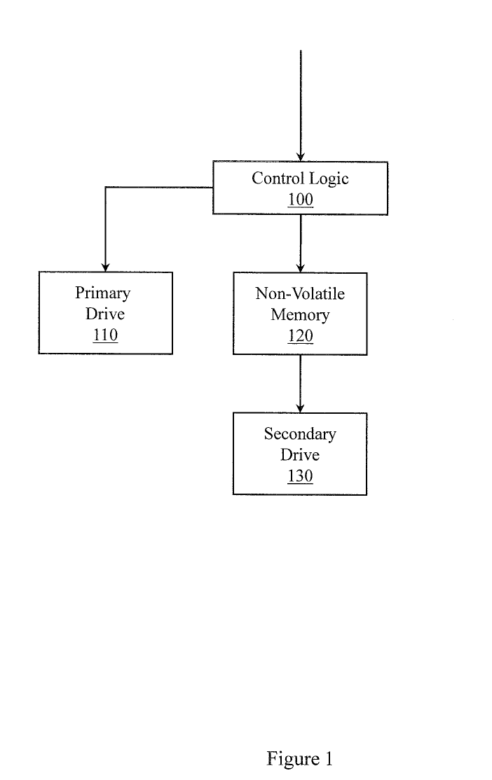

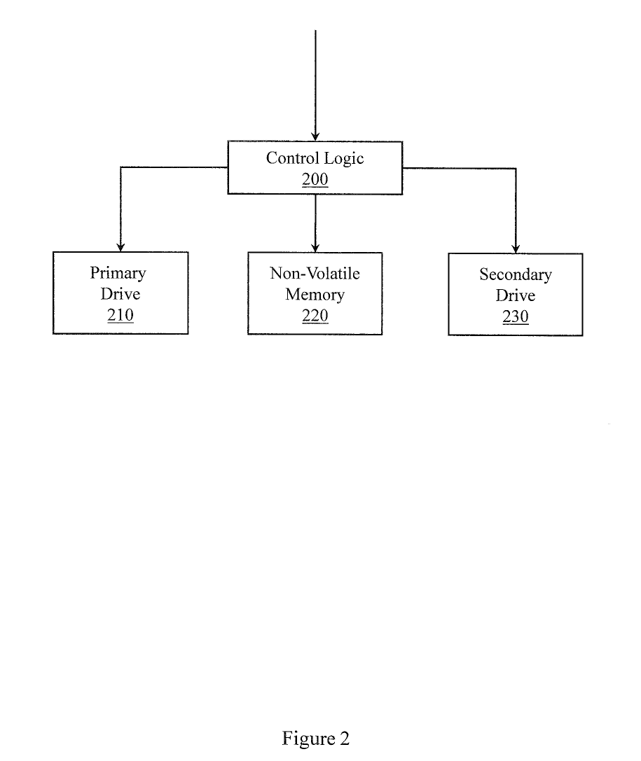

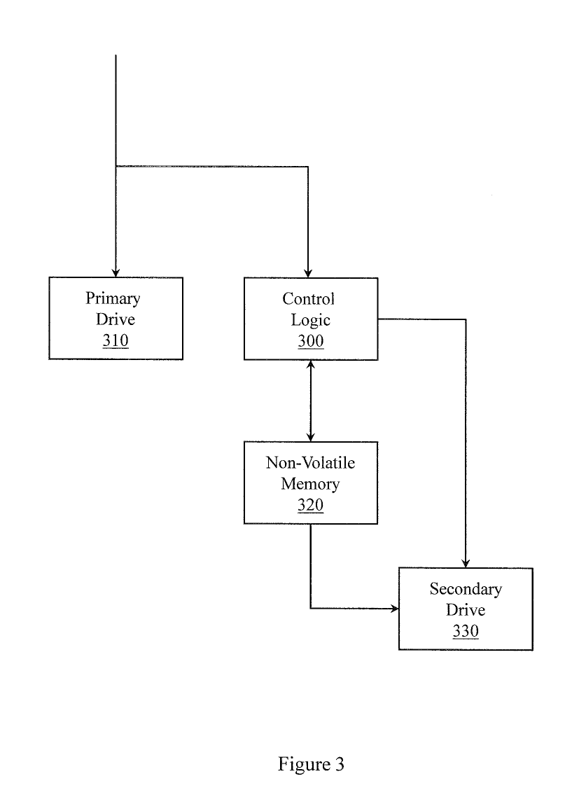

FIG. 1 illustrates one embodiment of control logic 100, a non-volatile memory 120, and a pair of drives arranged in a mirroring configuration. The pair of drives includes a primary drive 110 and a secondary drive 130. The control logic 100 is configured to be operatively coupled to the non-volatile memory 120 and to drives 110 and 130. The control logic 100 may be directly or indirectly connected to the primary drive 110 and the secondary drive 130. Other connection schemes are illustrated in FIGS. 2 and 3.

In one embodiment, the control logic 100 controls the primary drive 110 to be in a mirrored, powered-up, state. The control logic 100 also functions to control the secondary drive 130 to be in a mirroring, powered-down, state. Having the secondary drive 130 in a powered-down state saves power. However, having the secondary drive 130 in a powered-down state affects the ability of the secondary drive 130 to mirror writes provided to the primary drive 110. Therefore, control logic 100 can send data intended for the secondary drive 130 to the non-volatile memory 120 when the secondary drive 130 is in the powered-down state. Thus, the control logic 100 functions to cause a write intended for the primary drive 110 to be provided to the primary drive 110 when the primary drive 110 is in the powered-up, mirrored state and causes mirroring write data intended for the secondary drive 130 to be provided to the non-volatile memory 120 when the secondary drive 130 is in a powered-down, mirroring state.

In FIG. 1, a write intended for members of the pair of drives first arrives at control logic 100. The control logic 100 then functions to selectively provide mirroring write data intended to be written to the secondary drive 130 to be written instead to the non-volatile memory 120 when the secondary drive 130 is in a powered-down state. Other configurations of control logics, non-volatile memories, primary drives, and secondary drives are also illustrated herein. See, for example, FIGS. 2 and 3.

The non-volatile memory 120 may have a finite size. Therefore the control logic 100 may decide to write data from the non-volatile memory 120 to the secondary drive 130. The decision may be a function of time (e.g., periodically), a function of capacity (e.g., how full the non-volatile memory is), a function of a user input, and of other factors. The control logic 100 may selectively power up the secondary drive 130 to place the secondary drive 130 in a powered-up state. When the secondary drive 130 is in a powered-up state, the control logic 100 may then control the non-volatile memory 120 to selectively update the secondary drive 130 with data previously written to the non-volatile memory 120. After the data is written, two things may occur. The control logic 100 may selectively power down the secondary drive 130. The control logic 100 may also delete data from the non-volatile memory 120. Deleting data from the non-volatile memory 120 may be a logical or physical action. Thus, the control logic 100 may mark data in the non-volatile memory 120 as deleted, may over-write data in the non-volatile memory 120, may physically delete data in the non-volatile memory 120, and may take other actions. Control logic 100 may also update metadata in memory or in the non-volatile memory 120 to indicate that the data that has been written to the mirroring disk is no longer needed and that its space may be reused.

In one embodiment, control logic 100 may use non-volatile memory 120 as a sort of cache memory. In this embodiment, reads may be directed to the primary drive 110, but some reads could be directed to the non-volatile memory 120.

FIG. 2 illustrates a control logic 200, a non-volatile memory 220, and a pair of drives arranged in a mirroring configuration. The pair of drives includes a primary drive 210 and a secondary drive 230. In the configuration illustrated in FIG. 2, a write intended for members of the pair of drives first arrives at control logic 200. Control logic 200 may then determine to which of the non-volatile memory 220, the primary drive 210, and the secondary drive 230 the data will be provided. The configuration illustrated in FIG. 2 facilitates an embodiment of control logic 200 that functions to selectively swap the roles of the primary drive 210 and the secondary drive 230. At one point in time the primary drive 210 may be in a powered-up state and the secondary drive 230 may be in a powered-down state. At this point in time, the control logic 200 will write data intended for the secondary drive 230 to the non-volatile memory 220. At another point in time, the primary drive 210 may be in a powered-down state and the secondary drive 230 may be in a powered-up state. At this other point in time, the control logic 200 will write data intended for the primary drive 210 to the non-volatile memory 220. The control logic 200 may decide to swap the roles of the drives as a function of time (e.g., periodically), in response to a user input, and based on other factors.

While the control logic 200 is described as being coupled to the non-volatile memory 220, the primary drive 210, and the secondary drive 230, in one embodiment an apparatus may include the control logic 200 and the non-volatile memory 220. The non-volatile memory 220 may be, for example, a non-volatile random access memory (NVRAM) a FLASH-based disk drive, a fiber channel disk drive, a battery-backed up memory, a small computer system interface (SCSI) drive, and other memories. In one embodiment, an apparatus may include the control logic 200, the primary drive 210, the non-volatile memory 220, and the secondary drive 230. One skilled in the art will appreciate that there may be other configurations.

In one embodiment, the non-volatile memory 220 functions to store data intended for the secondary drive 230 as a collection arranged as a time sequential list of updates. An entry in the time sequential list of updates may take different forms and include different information. In one embodiment, an entry in the time sequential list of updates may include an identifier of a drive affected by a mirroring write, an identifier of a sector affected by the mirroring write, and write data intended for the mirroring drive. In one embodiment, an entry in the time sequential list of updates is arranged to facilitate maintaining write coherency. In another embodiment, the non-volatile memory 220 stores a linked list of structures relating drive cylinder updates to a cylinder hash table. An entry in the linked list of structures is arranged to facilitate maintaining write coherency.

FIG. 3 illustrates a control logic 300, a non-volatile memory 320, and a pair of drives arranged in a mirroring configuration. The pair of drives includes a primary drive 310 and a secondary drive 330. In the configuration illustrated in FIG. 3, a write intended for members of the pair of drives arrives at both primary drive 310 and non-volatile memory 320. Control logic 300 determines whether and when to write data from non-volatile memory 320 to the secondary drive 330. In one example, control logic 300, non-volatile memory 320, and secondary drive 330 may be packaged together as a green mirroring drive. The green mirroring drive may then interact with drive 310 (e.g., a disk drive). While FIGS. 1, 2, and 3 illustrate three different configurations of control logics, non-volatile memories, primary drives, and secondary drives, one skilled in the art will appreciate that other configurations can be employed. For example, control logic may be positioned in locations including, but not limited to, a host computing system, a host disk system, a disk controller, a disk array controller, and a plurality of disk controllers. Similarly, non-volatile memory may be positioned in locations including, but not limited to, a host computing system, a host disk system, a disk controller, a disk array controller, and a plurality of disk controllers. In one example, a control logic may be embodied as an operating system driver.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. It is to be appreciated that the methodologies are not limited by the order of the blocks, as some blocks can occur in different orders and/or concurrently with other blocks from that shown and described. Blocks may be combined or separated into multiple components. Furthermore, additional and/or alternative methodologies can employ additional, not illustrated blocks.

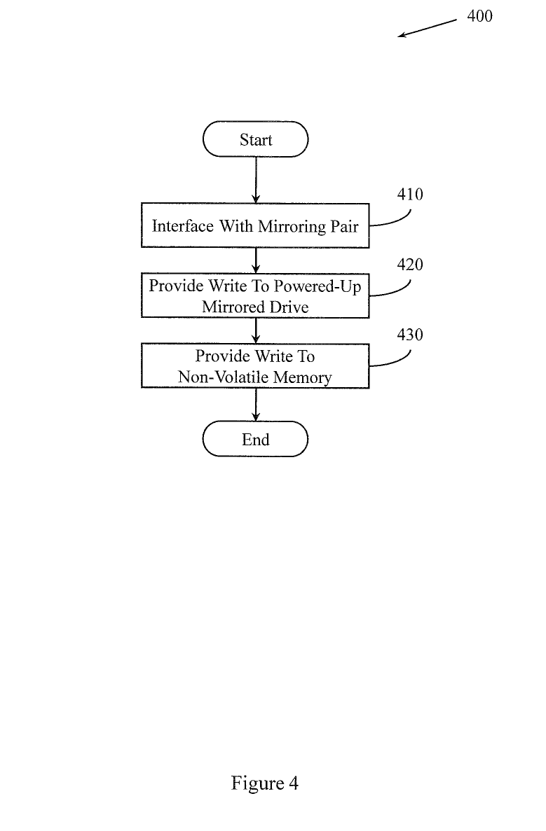

FIG. 4 illustrates a method 400 associated with providing mirroring write data to a non-volatile memory. Method 400 includes, at 410, interfacing with a pair of drives operating as a pair of mirroring drives. Interfacing with the pair of drives may include, for example, establishing a data path to the drives, establishing a control path to the drives, and other actions. In the pair of mirroring drives, one member of the pair of drives is controlled to be in a powered-up, mirrored state and one member of the pair of drives is controlled to be in a powered-down, mirroring state. While a pair of drives is mentioned, one skilled in the art will appreciate that a configuration of mirroring drives may include two or more drives. The drives may be, for example, disk drives, and other types of drives. Conventionally, all of the drives participating in the mirroring function would be powered-up. This may waste power. Therefore, method 400 facilitates having one or more drives that are participating in the mirroring function powered-down at least a part of the time.

Method 400 includes, at 420, controlling a write intended for the pair of drives to be provided to the drive in the powered-up, mirrored state. However, method 400 also includes, at 430, controlling the write intended for the drive in the powered-down, mirroring state to be provided to a non-volatile memory instead of to the drive in the powered-down, mirroring state. The non-volatile memory consumes less energy than a drive in a powered-up state and therefore there is a net savings of power.

Method 400 includes controlling the write intended for the drive in the powered-down, mirroring state to be provided to the non-volatile memory in a manner that maintains write coherency. This may include, for example, writing a time sequential list of updates to the non-volatile memory, writing an identifier of an affected drive to the non-volatile memory, writing an identifier of an affected sector to the non-volatile memory, writing data intended for the drive in the powered-down, mirroring state to the non-volatile memory, and manipulating a linked list structure on the non-volatile memory. A member of the linked list structure may relate cylinder updates and a cylinder hash table. Since write coherency is maintained, in one embodiment the non-volatile memory may be used to satisfy reads.

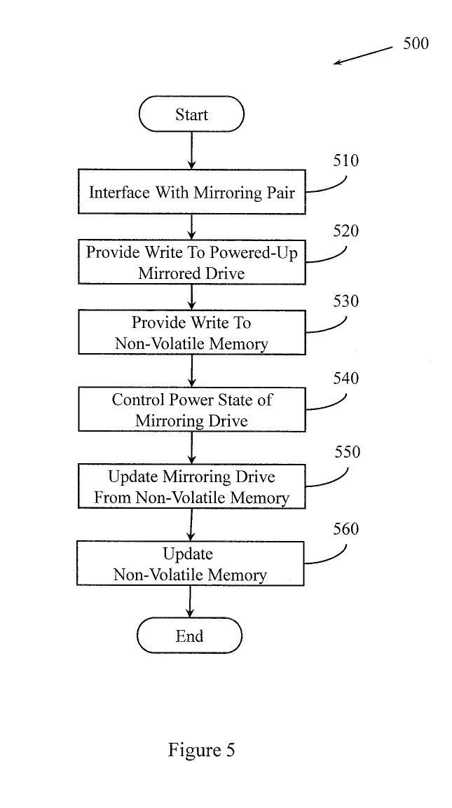

FIG. 5 illustrates a method 500 associated with providing mirroring write data to a non-volatile memory. Method 500 includes some actions similar to those described in connection with method 400 (FIG. 4). For example, method 500 includes interfacing with a mirroring pair at 510, providing write data to a powered-up mirroring drive at 520, and providing write data to a non-volatile memory at 530. The non-volatile memory cannot accept writes forever without eventually over-flowing or losing data. Therefore method 500 includes, at 540, selectively controlling the drive in the powered-down, mirroring state to enter a powered-up, mirroring state. This drive is now ready to receive data that had been written to the non-volatile memory. Method 500 therefore proceeds, at 550, to control the drive in the powered-up, mirroring state to receive data from the non-volatile memory. Since the non-volatile memory has disgorged its data, method 500 may then proceed, at 560, to selectively remove data from the non-volatile memory. Removing the data may be a physical and/or logical action.

It may be desirable to control the amount of time that drives spend in powered-up and powered-down states. For example, it may be desirable to balance wear between drives, to ensure that a drive is spun up at least once per period of time, to switch drives based on a user input, and so on. Therefore, in one embodiment, method 500 may include selectively reversing the roles of the pair of mirroring disk drives.

While FIGS. 4 and 5 illustrate various actions occurring in serial, it is to be appreciated that various actions illustrated in the example methods could occur substantially in parallel. By way of illustration, a first process could interface with a mirroring pair, a second process could provide data to a powered-up, mirrored drive, and a third process could provide write data to non-volatile memory. While three processes are described, it is to be appreciated that a greater and/or lesser number of processes could be employed and that lightweight processes, regular processes, threads, state machines, and other approaches could be employed.

In one example, a method may be implemented as computer executable instructions. Thus, in one example, a computer-readable medium may store computer executable instructions that if executed by a machine (e.g., processor) cause the machine to perform method 400, method 500, and equivalents. “Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

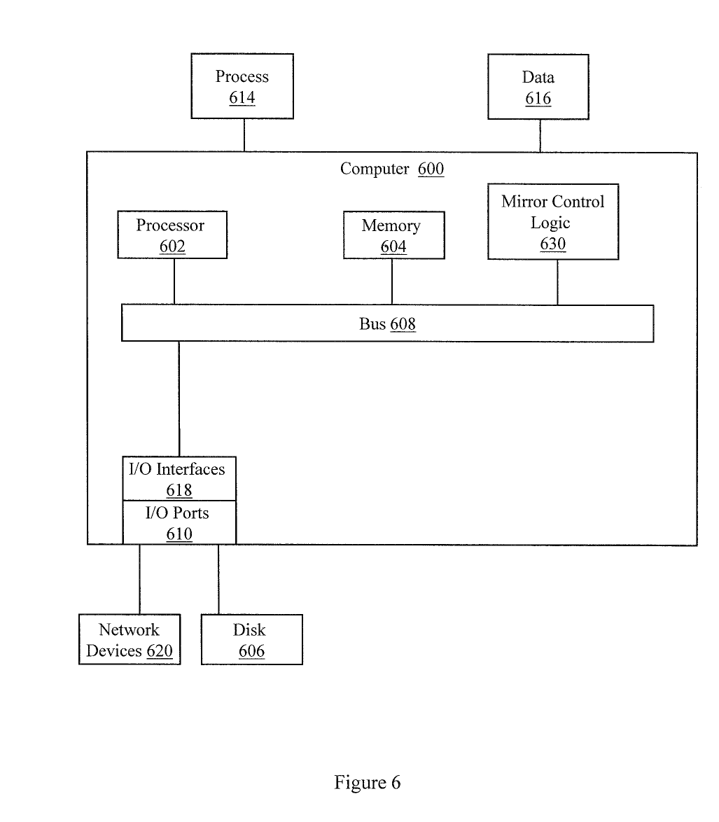

FIG. 6 illustrates a computing environment in which apparatus and methods associated with providing mirroring write data to a non-volatile memory may operate. The example computing device may be a computer 600 that includes a processor 602, a memory 604, and input/output ports 610 operably connected by a bus 608. In one example, the computer 600 may include a mirror control logic 630 that functions to facilitate providing mirroring write data to non-volatile memory. In different examples, the logic 630 may be implemented in hardware, software, firmware, and/or combinations thereof. While the logic 630 is illustrated as a hardware component attached to the bus 608, it is to be appreciated that in one example, the logic 630 could be implemented in the processor 602.

Logic 630 may provide means (e.g., hardware, software, firmware) for servicing reads from a member of a set of mirroring drives that is in a powered-up state. The means may be implemented, for example, as an ASIC. The means may also be implemented as computer executable instructions that are presented to computer 600 as data 616 that are temporarily stored in memory 604 and then executed by processor 602. Logic 630 may also provide means (e.g., hardware, software, firmware) for periodically updating a member of the set of mirroring drives that is in the powered-down state with data from the non-volatile memory.

Generally describing an example configuration of the computer 600, the processor 602 may be a variety of various processors including dual microprocessor and other multi-processor architectures. A memory 604 may include volatile memory and/or non-volatile memory. A disk 606 may be operably connected to the computer 600 via, for example, an input/output interface (e.g., card, device) 618 and an input/output port 610. The disk 606 may be, for example, a magnetic disk drive, a solid state disk drive, and other types of drives. The memory 604 can store a process 614 and/or a data 616, for example. The disk 606 and/or the memory 604 can store an operating system that controls and allocates resources of the computer 600.

The bus 608 may be a single internal bus interconnect architecture and/or other bus or mesh architectures. While a single bus is illustrated, it is to be appreciated that the computer 600 may communicate with various devices, logics, and peripherals using other busses (e.g., PCIE, 1394, USB, Ethernet, Hypertransport). The bus 608 can be types including, for example, a memory bus, a memory controller, a peripheral bus, an external bus, a crossbar switch, and/or a local bus.

The computer 600 may interact with input/output devices via the i/o interfaces 618 and the input/output ports 610. Input/output devices may be, for example, a keyboard, a pointing and selection device, the disk 606, and the network devices 620. The input/output ports 610 may include, for example, serial ports, parallel ports, and USB ports.

The computer 600 can operate in a network environment and thus may be connected to the network devices 620. Through the network devices 620, the computer 600 may interact with a network. Through the network, the computer 600 may be logically connected to remote computers. Networks with which the computer 600 may interact include, but are not limited to, a LAN, a WAN, and other networks.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. An apparatus, comprising:
control logic configured to be operatively coupled to a non-volatile memory and to a plurality of drives organized in a mirroring configuration, the mirroring configuration comprising a primary drive and a secondary drive; and
where the control logic functions to selectively provide mirroring write data intended to be written to the secondary drive to the non-volatile memory when the secondary drive is in a powered-down state.

2. The apparatus of claim 1, where the control logic functions to control the primary drive to be in a mirrored, powered-up, state, and where the control logic functions to control the secondary drive to be in a mirroring, powered-down, state; and
where the control logic functions to cause a write intended for the primary drive to be provided to the primary drive when the primary drive is in the powered-up, mirrored state and to cause mirroring write data intended for the secondary drive to be provided to the non-volatile memory when the secondary drive is in a powered-down, mirroring state.

3. The apparatus of claim 1, where the control logic is configured to selectively update the secondary drive by writing data from the non-volatile memory to the secondary drive based at least in part on a function of time, a function of capacity of the non-volatile memory, or a function of a user input.

4. The apparatus of claim 3, where the control logic functions:
to selectively power up the secondary drive to place the secondary drive in a powered-up state;
to control the non-volatile memory to selectively update the secondary drive with data previously written to the non-volatile memory; and
to selectively power down the secondary drive.

5. The apparatus of claim 4, where the control logic is configured to selectively perform one or more of, deleting data from the non-volatile memory, marking data in the non-volatile memory as deleted, or over-writing data in the non-volatile memory.

6. The apparatus of claim 1, further comprising:
the non-volatile memory, and
where the non-volatile memory is a non-volatile random access memory (NVRAM), a FLASH-based disk drive, a fiber channel disk drive, a battery-backed up memory, or a small computer system interface (SCSI) drive.

7. The apparatus of claim 1, where the non-volatile memory functions to store data intended for the secondary drive as a collection arranged as a time sequential list of updates, and where the control logic functions to selectively satisfy a read from the non-volatile memory.

8. The apparatus of claim 7, where an entry in the time sequential list of updates comprises, an identifier of a drive affected by a mirroring write, an identifier of a sector affected by the mirroring write, and write data intended for the mirroring drive, and where an entry in the time sequential list of updates is arranged to facilitate maintaining write coherency, and
where the non-volatile memory is configured to store a linked list of structures relating drive cylinder updates to a cylinder hash table, where an entry in the linked list of structures is arranged to facilitate maintaining write coherency.

9. The apparatus of claim 1, where the control logic functions to selectively swap the roles of the primary drive and the secondary drive.

10. The apparatus of claim 6, the apparatus being positioned in one or more of, a host computing system, a host disk system, a disk controller, a disk array controller, and a plurality of disk controllers.

11. A computer-readable medium storing computer-executable instructions that when executed by a computer cause the computer to perform a method, the method comprising:
interfacing with a pair of drives operating as a pair of mirroring drives, where one member of the pair of drives is controlled to be in a powered-up, mirrored state and where one member of the pair of drives is controlled to be in a powered-down, mirroring state;
controlling a write intended for the pair of drives to be provided to the drive in the powered-up, mirrored state; and
controlling a write intended for the drive in the powered-down, mirroring state to be provided to a non-volatile memory instead of to the drive in the powered-down, mirroring state,
where the write intended for the device in the powered-down, mirroring state is a mirroring write associated with the write intended for the drive in the powered-up, mirrored state.

12. The computer-readable medium of claim 11, further comprising stored executable-instructions for:
selectively controlling the drive in the powered-down, mirroring state to enter a powered-up, mirroring state;
controlling the drive in the powered-up, mirroring state to receive data from the non-volatile memory; and
selectively removing data from the non-volatile memory.

13. The computer-readable medium of claim 11, further comprising stored executable-instructions for:
selectively reversing the roles of the pair of mirroring disk drives; and
where controlling the write intended for the drive in the powered-down, mirroring state to be provided to the non-volatile memory comprises:
controlling the write to maintain write coherency by performing one or more of, writing a time sequential list of updates to the non-volatile memory, writing an identifier of an affected drive to the non-volatile memory, writing an identifier of an affected sector to the non-volatile memory, writing data intended for the drive in the powered-down, mirroring state to the non-volatile memory, and manipulating a linked list structure on the non-volatile memory, where the linked list structure relates cylinder updates and a cylinder hash table.

14. A system, comprising:
means for controlling a power state of members of a set of mirroring drives; and
means for temporarily storing, in a non-volatile memory, mirroring data intended for a member of the set of mirroring drives that is in a powered-down state.

15. The system of claim 14, comprising:
means for servicing reads from one drive of the set of mirroring drives that is in a powered-up state; and
means for periodically updating the member of the set of mirroring drives that is in the powered-down state with data from the non-volatile memory.
